(19) United States
(12) Patent Application Publication
(10) Pub. No.: US 2004/0044584 A1
(43) Pub. Date: Mar. 4, 2004

(54) Method of placing order for product with specific composition via online shopping

(76) Inventor: Yuan-Fen Chung, Taipei Hsien (TW)

Correspondence Address: BRUCE H. TROXELL, SUITE 1404, 5205 LEESBURG PIKE, FALLS CHURCH, VA, 22041, US

(21) Appl. No.: 10/648,199

(22) Filed: Aug. 27, 2003

(30) Foreign Application Priority Data
Aug. 27, 2002 (TW) 091119576

(51) Int. Cl. G06F 17/60

(52) U.S. Cl. 705/26

(57) ABSTRACT

This invention discloses a method of placing order for a product with specific composition via online shopping, comprising a logon procedure that requires a buyer to enter a website by logging on the Internet; an order placement procedure that lets the buyer open a web page and click the desired purchase item as well as each material of the production with specific composition and their prices, and the buyer can specify the type and proportion of the specific composition, and then the web page calculates the price and lets the buyer confirm the price; a package confirmation procedure that opens a packaging web page and displays different kinds of packaging methods, styles, and prices, and after the buyer has specified the requirements, the web page shows the price of the whole package; and a billing procedure that allows the buyer to confirm the purchase quantity and payment term to complete the order.

### BACKGROUND OF THE INVENTION

1. Field of the Invention

The present invention relates to a method of placing an order, more particularly to a method of placing an order for a product with specific composition via online shopping.

2. Description of the Related Art

The conduct of commercial transactions has been simplified into different trading modes, and is done in different ways at different time. For example, the Barter system in ancient time refers to exchanging goods with goods, and the platinum, gold, money, paper money, check, money remittance are also used as an instrument for making payment. The trading medium has changed from fair, store, to mail order. As to the application of credit instruments such as a credit card, online shopping can be paid by credit cards, which indicates the cultural development of mankind.

In fact, products can be divided into those manufactured according to a specification and those manufactured according to the composition of consumer's personal preference. As to the manufacturers, products with specification fit the mass production due to the convenience in its planned production management, inventory, sales, and marketing. Products of this kind can save lots of troubles of providing custom-made products to meet individual customer's requirements.

However, when we take the consumer's right seriously, and a product can uniquely shows the purchaser's identity and social status, custom-made products made according to personal taste or consumer's preference become a way of attracting customers and marketing products. It can yet be regarded as an efficient instrument, particularly in the markets with such severe competition. Products including clothes, watches, pens, and cars, etc have the tendency of satisfying consumer's personal preference.

In addition, most of the daily food and beverages or hobby gift items such as cigarettes, wines, and coffees, etc. are products with a specification and generally produced by mass production. Therefore, consumers just need to follow the specifications of the product for their choices. It is regretful to have the shortcoming that consumers cannot buy a product according to their personal preference. More particularly, taste and flavor are our basic sense perceptions, and it is very helpful to the market development if these sense perceptions can be guided predominantly.

In view of the description above, the inventor of this invention based on years of experience engaging in the product development and marketing of the related industry to perform a research to integrate the online shopping technology and offer a way of selling products with the composition according to personal preference. After a series of researches, the inventor finally invented the “method of placing order for product with specific composition via online shopping” in accordance with this invention.

### SUMMARY OF THE INVENTION

The objective of this invention is to provide a method of placing an order for a product with specific composition via online shopping.

### BRIEF DESCRIPTION OF THE DRAWING

Other features and advantages of the present invention will become apparent in the following detailed description of the preferred embodiments with reference to the accompanying drawing, in which:

FIG. 1 is a flow chart showing the architecture of the present invention.

### DETAILED DESCRIPTION OF THE PREFERRED EMBODIMENTS

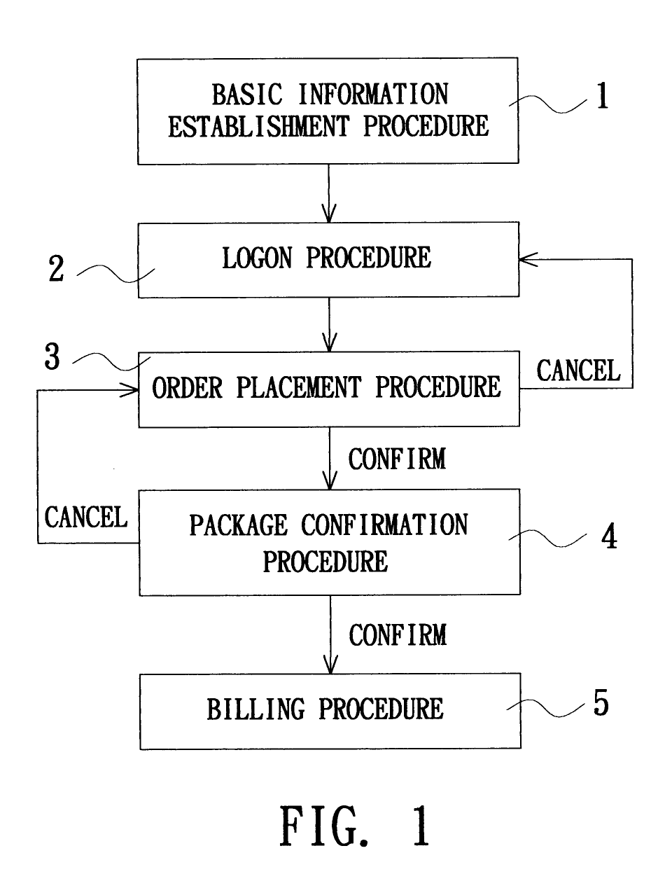

Please refer to FIG. 1 for the present invention. The method in accordance with this invention comprises the steps of: a basic information establishment procedure 1, a logon procedure 2, an order placement procedure 3, a package confirmation procedure 4, and a billing procedure 5.

In which, the basic information establishment procedure 1 refers to the procedure for a potential purchaser who wants to buy a product with specific composition and the purchaser inputs basic data such as the purchaser's name, telephone number, email address, receiver's name, and ship-to address after entering into the website of the seller or the supplier. If an online shopping is for members only, then a customer number is assigned to the purchaser, so that the purchaser can enter the website directly for the online shopping next time. However, such file creation relates to the prior art, and thus will not be described here.

The logon procedure 2 refers to the operation for a consumer who enters into shopping area of the website. It generally requires a password to enter the website. As mentioned before, the consumer can enter the membership number as the authentication code. However, it also relates to the prior art and thus will not be described here.

The order placement procedure 3 refers to the procedure for a purchaser to select the desired merchandiser such as cigarettes, wines, coffee, medicine, etc after entering on the list of merchandise type displayed on the server of the seller's website. After the purchaser has selected a merchandise item, the screen will enter the screen of selecting the specific composition for such merchandise. Taking the types of cigarettes as examples, the following screen may appear, and the purchaser may enter the choices into the “Mixing Ratio” column according to the purchaser's personal preference as shown below:

| | | Mixture | |
|---|---|---|---|
| Tobacco | Unit Price | Ratio (%) | Remark |
| Long Life | NT $1.50/cigarette | 25 | Choices with an |
| Tobacco | | | increment of 5% |
| President | NT $2.50/cigarette | 50 | can be made. |
| Tobacco | | | |
| Cigar Tobacco | NT $8.50/cigar | 20 | |
| . . . | | | |
| Additive | | | Choices with an |
| Mugwort | | 3 | increment of 1% |
| Spice | | 2 | can be made. |
| . . . | | | |
| Additive Added | Total Number of | 2 | Deliver shipment to |
| by Customer | Types | | the customer |
| | | | within 1 week after |
| | | | order confirmation. |

Total Price Per Cigarette: NT $16.85

Then, the server will calculate the price per cigarette according to the foregoing mixture ratio as follows:

The total price per cigarette is calculated according to the following formula:

[(Tobacco*%)+ . . . +(Additive*%)+ . . . ]*Total Number of Types of Tobacco and Additives*0.4=[(1.5*0.25)+(2.5*0.5)+(8.5*0.2)+(50*0.03)+(180*0.02)]*5*0.4=8.425*5*0.4=16.85

Then, the purchaser either confirms or cancels the choice. If the choice is cancelled, then it will return to the menu of choosing the types of supplying goods.

The package confirmation procedure 4 relates to the choices of packages of different number of cigarettes and packing material and style. Thus, the following screen will appear:

CHOICE FOR PACKAGE, PACKING MATERIAL, AND SURFACE
TREATMENT
(20-CIGARETTE PACKAGE)

| | Cigarette | | | | |
|---|---|---|---|---|---|
| | Paper Material | | | | |
| | | 150-lb | Surface Processing | | |
| | 80-lb | Shuang | | | |
| | Dao Lin | Tong | Light | Shiny | Stamped |
| Style | Paper | Paper | Coating | Film | Grid |
| Style A (1) | | | | | (3) |
| Style B | | (2) | | | |
| . . . | | | | | |

Price for packaging each pack of cigarettes:
Price for packaging each cigarette = Price for packaging each pack of cigarettes/20

After the choice is made, the server will calculate the packaging cost of such plain material. Then, the purchaser can select the same style, and the following screen will appear:

| | | | | |
|---|---|---|---|---|
| Style 1 | Style 2 | Style 3 | Style 3 | Style 4 |
| Style 6 | Style 7 | Style 8 | Style 9 | Style 10 |

These styles will be enlarged after being clicked, so that the purchaser can have a clear look for the browsing, and also can print it out at the purchasers end.

After the choices have been made, the price of each pack can be calculated. The purchaser confirms the price to complete the packaging procedure. If the purchaser wants to cancel the choice, the purchaser just needs to press the cancel button to return to the previous step (Order Placement Procedure).

The billing procedure 5 refers to the procedure for the seller or its server end to calculate the total price according to the quantity required by the purchaser and let the purchaser confirm the price and the way of making payment. The ways of making payment include paying by credit card for individuals, or paying on delivery according to the payment terms for distributors or retailers. However, the ways of making payment will not be described here.

Therefore, it is known from the foregoing preferred embodiment that the supply of products with specific composition can extensively exploit more customer sources. As to the consumers or distributors, this invention can accommodate the consumer's requirements of the purchase order.

Now, taking the liquors for example, the screen at the Step (3) Order Placement Procedure will appear as follows:

1. SELECTING THE LIQUORS AND ADDITIVES

| | | Mixture | |
|---|---|---|---|
| Liquor | Unit Price | Ratio (%) | Remark |
| Kao Liang Liquor | NT $4/cc | | Choices with an |
| 50 Proof | | | increment of 10% can |
| Kao Liang Liquor | NT $2.50/cc | | be made. |
| 36 Proof | | | |
| Wine 20 Proof | NT $1.50/cc | | |
| Rice Wine 15 | NT $0.50/cc | | |
| Proof | | | |
| Beer 8 Proof | NT $0.10/cc | 70 | |
| . . . | | | |
| Liquid Additive | | | Choices with an |
| Tomato Juice | NT $0.02/cc | 30 | increment of 5% can |
| 100% | | | be made. |
| Orange Juice | NT $0.02/cc | | |
| 100% | | | |
| . . . | | | |
| Solid Additive | | | Choices with an |
| Angelica Root | NT $80/100 g | 10 | increment of 100 g |
| Matrimony Vine | NT $10/100 g | | can be made. |
| . . . | | | |
| Customer's | Total Number of | 1 | Deliver shipment to |
| Additive | Types | | the customer within 1 |
| | | | week after order |
| | | | confirmation. |

Total Price Per Bottle: NT $201.60

The total price per bottle is calculated according to the following formula:

[(Volume of Container*Liquor %*Unit Price of Liquor)+ . . . +(Volume of Container*Liquid Additive %*Unit Price of Liquid Additive)+ . . . +(Unit Price of Solid Additive*Weight/No. of Purchased Bottles)+ . . . +Unit Price of Container+Total Price of Packaging Container]*Total Number of Types of Liquor and Additive*0.4.

Assumed that the foregoing example adopts ceramic bottle with a capacity of 500 cc, and the unit price of the bottle is NT$50, and the total packaging price per bottle is NT$40.

The total price per bottle=[(500*0.1*0.7)+(500*0.02*0.3)+(80*10/20)+(50) +(40)]*3*0.4=201.6 (NT$/bottle)

Then, the screen of the packaging procedure 4 will appear as follows:

2. Types of Containers

2-1. Selecting the container (glass bottle, ceramic bottle, Tetra Pak, or portable package, etc)

| | Style | | | |
|---|---|---|---|---|
| | Style 1 | Style 2 | Style 3 | Style 4 |
| No. of Purchased Bottles | 20 | | | |

Note:
After the style has been selected, the pattern of the container will be enlarged and the price, material, and capacity will be stated.

2-1-1. Pattern of container (Manufacture of Bottle, Printing of Tetra Pak, and Printing of Portable Package)

A. The pattern file will be attached.

A-1. Reference Pattern files:

| | | | | |
|---|---|---|---|---|
| Style 1 | Style 2 | Style 3 | Style 3 | Style 4 |
| Style 6 | Style 7 | Style 8 | Style 9 | Style 10 |

Note:
These styles will be enlarged after being clicked, and the price will be stated.

The steps below will follow:

A-2. Opening File: the customer's pattern or picture will be shown.

A-3. Browsing

A-4. Confirming

A-5. Canceling

A-6. Saving as Another File

B. Previewing Printed Pattern (showing the actual situation after the container is labeled)

C. Printing Pattern

D. Canceling Attached FIG.

2-1-2. Container Label

2-1-3. Container Wrap Pattern (for bottle)

2-1-4. Listing Total Price of Container and Related Package

2-1-5. Confirmation

2-1-6. Cancellation.

The billing procedure 5 shows the confirmation on total quantity, total price, payment terms, and ways of making payment. Then, it ends the transaction and starts following up the delivery of shipments. However, delivering shipments is a prior art, and thus will not be described here.

Therefore, the implementation of this invention allows e-Commerce to enter into a new area of placing orders for products with specific composition according to personal preference or specific recipe, which the prior-art e-Commerce is unable to accomplish, and is a breakthrough of traditional way of shopping.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method of placing order for product with specific composition via online shopping; comprising the steps of:
a logon procedure, for a purchaser to enter into the website through Internet;
an order placement procedure for opening a web page and selecting a desired purchase item, and further opening each ingredient and its price of the product with specific composition, and allowing the purchaser to specify the type and proportion of ingredients, and then the web page calculating the price for the purchaser's confirmation;
a package confirmation procedure, for opening a packaging web page indicating a plurality of packaging styles, patterns, and prices; after the purchaser specifying the order, the web page showing the packaging price for the purchaser's confirmation; and
a billing procedure, for allowing the purchaser to confirm the purchase quantity and the way of making payment, and then ending the purchase order.

2. The method of placing order for product with specific composition via online shopping of claim 1 further comprising a basic information establishment procedure for the purchaser to enter related personal information for the purchase of the first time.

3. The method of placing order for product with specific composition via online shopping of claim 1, wherein said logon procedure requires a password to log on.

4. The method of placing order for product with specific composition via online shopping of claim 1, wherein said order placement procedure returns to a previous screen for selection if confirmation is not made.

5. The method of placing order for product with specific composition via online shopping of claim 1, wherein said order placement procedure adds a web page for suggesting the proportion of the ingredients for the purchaser's choice.

6. The method of placing order for product with specific composition via online shopping of claim 1, wherein said packaging confirmation procedure has separate web pages for packaging material and pattern styles.

7. The method of placing order for product with specific composition via online shopping of claim 1, wherein said packaging procedure returns to a previous screen for selection if confirmation is not made.

8. The method of placing order for product with specific composition via online shopping of claim 1, wherein said billing procedure further comprising the confirmation of purchase quantity, total price, way of making payment, delivery date, and transportation method.
